(19) United States
(12) Patent Application Publication
(10) Pub. No.: US 2010/0095823 A1
(43) Pub. Date: Apr. 22, 2010

(54) BENCH CUTTER

(75) Inventors: Ryuuichi Imamura, Ibaraki (JP); Takamoto Horiuchi, Ibaraki (JP)

Correspondence Address: KIMBLE INTELLECTUAL PROPERTY LAW, PLLC, 1701 PENNSYLVANIA AVE., NW, SUITE 300, WASHINGTON, DC, 20006, US

(73) Assignee: Hitachi Koki, Co., Ltd., Tokyo (JP)

(21) Appl. No.: 12/529,180

(22) PCT Filed: Mar. 14, 2008
(86) PCT No.: PCT/JP2008/055343

§ 371 Date: Aug. 28, 2009

(30) Foreign Application Priority Data
Mar. 16, 2007 (JP) 2007-067844

(51) Int. Cl. B26D 1/14

(52) U.S. Cl. 83/477.1

(57) ABSTRACT

In a bench cutter in which a turn table 2 is fitted to be held by a base 1 horizontally pivotably, a fence 3 for supporting a member to be worked 35 is fixed onto the base 1, a rear side of the turn table 2 is provided with a holder 5 inclinably erected at the base 1, a sliding member is connected to an upper portion of the holder 5, a circular saw portion 12 is held in parallel and slidably in a front and rear direction relative to an upper face of the base 1 and pivotably in an up and down direction relative to the upper face of the base 1, a saw blade 14 and a handle 26 are provided at the circular saw portion 12, and the member to be worked 35 is cut by inclining, pivoting in an up and down direction and sliding in a front and rear direction the circular saw portion 12, a roller 18 is provided at a lower portion of a rear side of the turn table 2 in parallel with a direction of sliding the circular saw portion 12 by being moved up from an installing face of the base 1.

### TECHNICAL FIELD

The present invention relates to a bench cutter which is provided in parallel and slidably in a front and rear direction relative to an upper face of a base portion and a circular saw portion of which is provided inclinably and pivotably in an up and down direction relative thereto.

### BACKGROUND ART

According to a bench cutter of a background art, there is adopted a system of holding and moving and carrying the bench cutter by using a carrying handhold formed at a side face of a base, a carrying handle provided at a circular saw portion or the like.

### DISCLOSURE OF THE INVENTION

When a bench cutter is moved or carried by the background art system, it is necessary to move up the bench cutter from an installing face in order to hold the bench cutter by the both hands. Further, an operation of carrying a bench cutter which is a highly weighted object is accompanied by hard labor to pose a problem in a carrying performance such that the both hands are occupied therewith or the like.

The invention has been carried out in view of the problem, and it is an object thereof to provide a bench cutter capable of being moved or carried with excellent operability and easily.

In order to achieve the object, the invention according to claim 1 is a bench cutter in which a turn table is fitted to be held by a base portion horizontally pivotably, a fence for supporting a member to be worked is fixed onto the base portion, a rear side of the turn table is provided with a holder erected inclinably to the base portion, a circular saw portion is held in parallel and rotatably in an up and down direction relative to the upper face of the base portion, the circular saw portion is provided with a saw blade and a handle, and the member to be worked is cut by inclining, pivoting in the up and down direction and sliding in the front and rear direction the circular saw portion. A roller is provided with at least one of the base and the turn table.

According to the invention according to claim 2, in the invention according to claim 1, the rollers are provided on left and right sides relative to an extension of the saw blade.

According to the invention according to claim 3, in the invention according to claim 1 or 2, the roller is provided to be able to be contained in the turn table.

According to the invention according to claim 4, in the invention according to claim 1 or 2, the roller is held movably in the front and rear direction.

According to the invention according to claim 1, the rollable roller is provided on the rear side of the turn table, and therefore, the bench cutter can be moved or carried with excellent operability and easily.

According to the invention according to claim 2, by providing two pieces of the rollers, a stability in carrying the bench cutter can be promoted.

According to the invention according to claim 3, the roller projected from the edge portion of the turn table is made to be able to be contained, and therefore, the roller does not constitute a hindrance, and operability of the bench cutter is not deteriorated by the roller.

According to the invention according to claim 4, by holding the roller movably in the front and rear direction, a height in carrying the bench cutter can be adjusted, and the bench cutter can be carried out in an easy attitude.

According to the invention relative to claim 5, the bench cutter according to claim 1, further includes: a sliding member is connected to an upper portion of the holder. The circular saw portion is slidable in a front and rear direction relative to an upper face of the base portion.

According to the invention relative to claim 6, the roller is provided at a lower portion of a rear side of the turn table in parallel with a direction of sliding the circular saw portion in the front and rear direction by being moved up from an installing face of the base.

### BRIEF DESCRIPTION OF THE DRAWINGS

FIG. 1 is a left side view of a bench cutter according to embodiment 1 of the invention.

FIG. 2 is a front view of the bench cutter according to embodiment 1 of the invention.

FIG. 3 is a left side view showing a cutting position of the bench cutter according to embodiment 1 of the invention.

FIG. 4 is a rear view of a turn table of the bench cutter according to embodiment 1 of the invention.

FIG. 5 is a right side view of a circular saw portion of the bench cutter according to embodiment 1 of the invention.

FIG. 6 is a sectional view taken along a line A-A of FIG. 5.

FIG. 7 is a left side view showing a state in carrying the bench cutter according to embodiment 1 of the invention.

FIG. 8 is a left side view of a bench cutter according to embodiment 2 of the invention.

FIG. 9 is a rear view of a turn table of the bench cutter according to embodiment 2 of the invention.

FIG. 10 is a left side view of a bench cutter according to embodiment 3 of the invention.

FIG. 11 is a rear view of a turn table of the bench cutter according to embodiment 3 of the invention.

### BEST MODE FOR CARRYING OUT THE INVENTION

An embodiment of the invention will be explained as follows in reference to the attached drawings.

### Embodiment 1

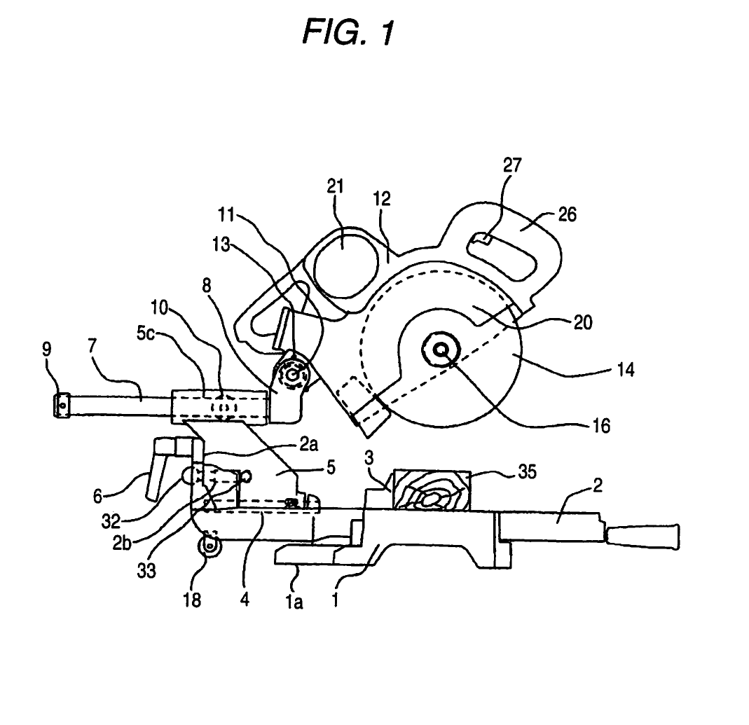

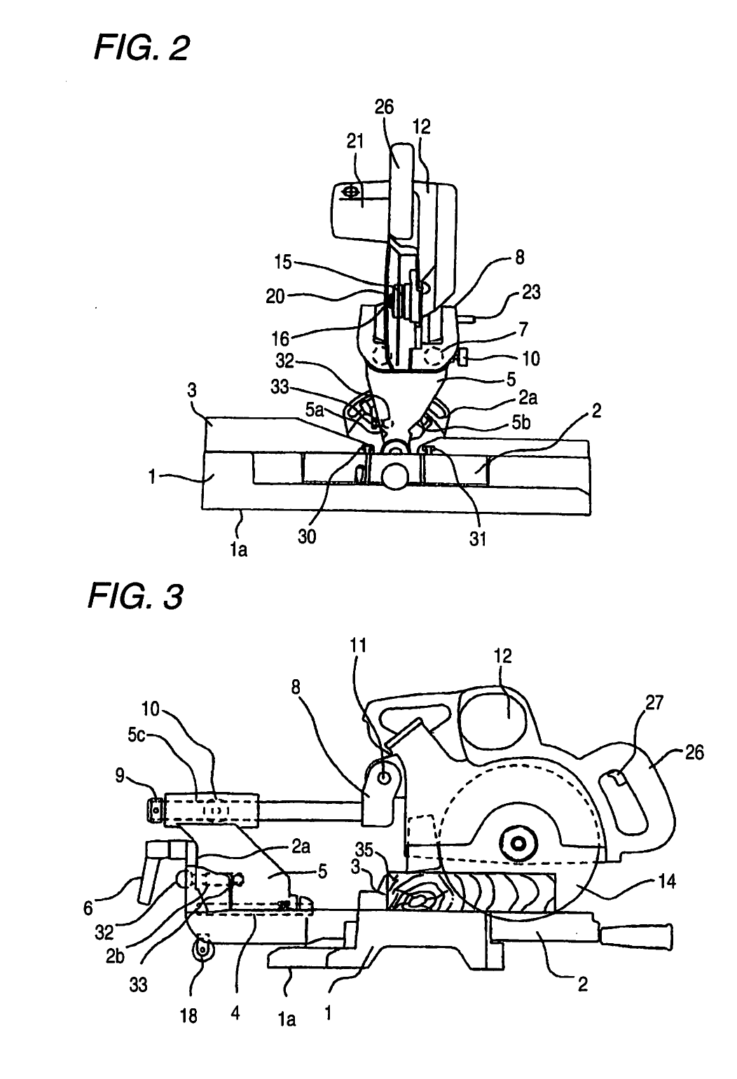

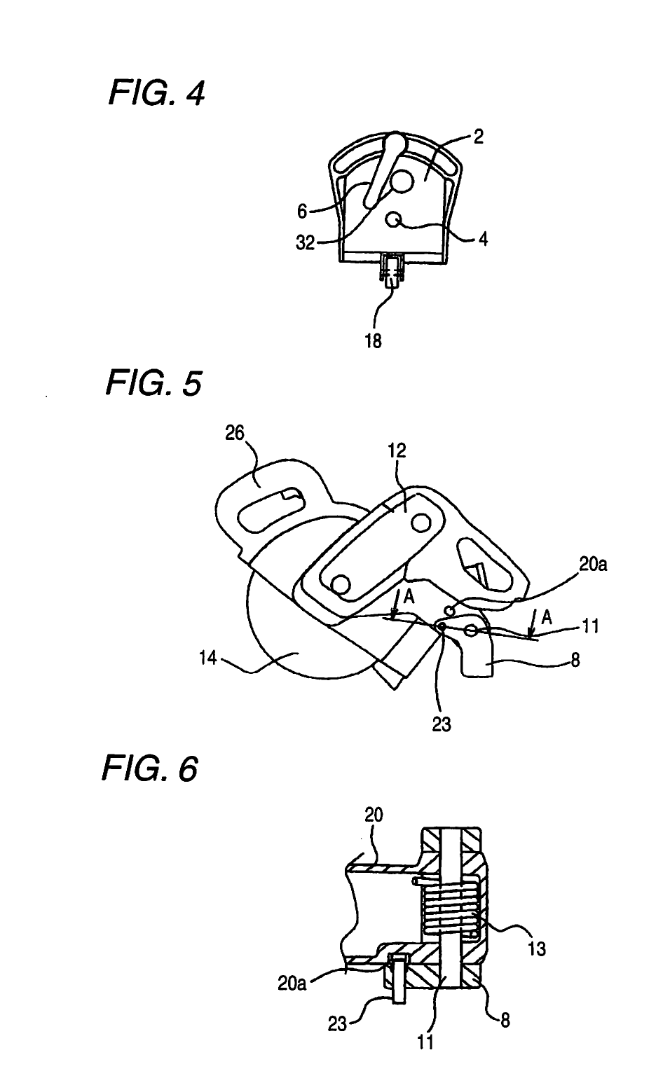

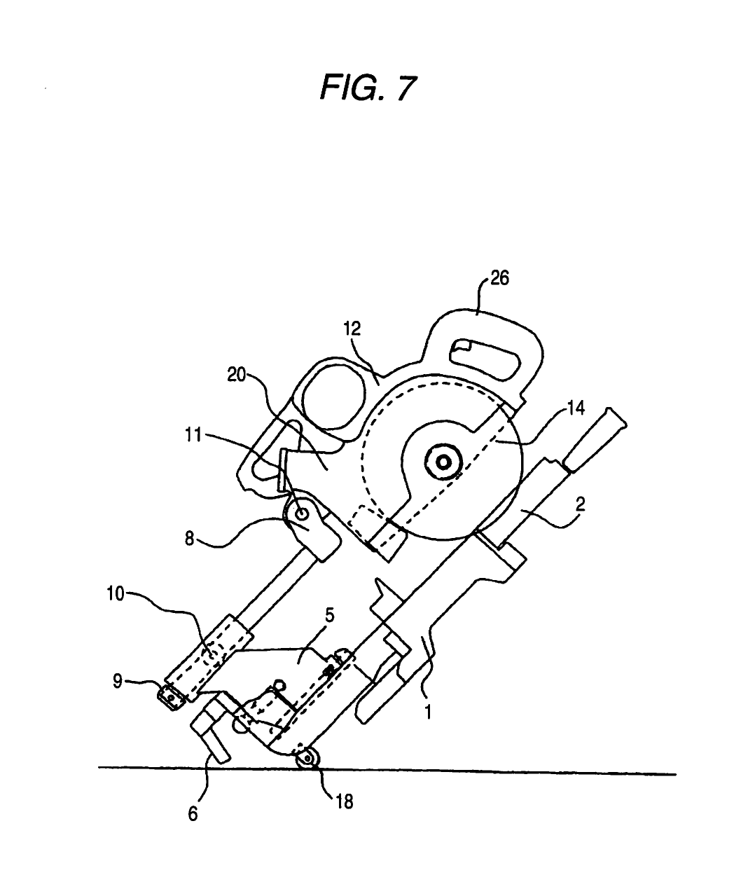

FIG. 1 is a left side view of a bench cutter according to the invention. FIG. 2 is a front view of the bench cutter, FIG. 3 is a left side view showing a cutting position of the bench cutter, FIG. 4 is a rear view of a turn table of the bench cutter, FIG. 5 is a right side view of a circular saw portion of the bench cutter, FIG. 6 is a sectional view taken along a line A-A of FIG. 5, and FIG. 7 is a left side view showing a state in carrying the bench cutter.

In a bench cutter according to the invention, a center of a base 1 is embedded with a turn table 2 horizontally, pivotably, and an upper face of the turn table 2 constitutes a face flush with an upper face of the base 1. The upper faces of the base 1 and the turn table 2 are mouthed with a member to be worked 35 of wood or the like. Further, in the following explanation, a portion mounted with the member to be worked 35 (according to the embodiment, the base 1 and the turn table 2) is generally referred to as ‘base portion’.

The upper face of the base 1 is fixed with a fence 3 for supporting a side face of the member to be worked 35, and a rear end of the turn table 2 is erected with a holder 5 constituting a support member by way of a holder shaft 4. Further, by making an axis center of the holder shaft 4 substantially coincide with the upper face of the turn table 2, the holder 5 is axially supported inclinably in a left and right direction centering on the upper face of the turn table 2 by constituting a fulcrum by the holder shaft 4.

As shown by FIG. 1, by rotating a lever 6 of a rear portion of the turn table 2, the holder 5 is brought into close contact with a face 2a of the turn table 2 to fix inclination of the holder 5. Further, the holder 5 is constituted to be able to be inclined by about 45° in the left and right direction.

In a state of right angle cutting (a state in which the holder 5 is erected orthogonal to the turn table 2), through holes 5c are bored at two upper portions of the holder 5, slide and hold members, not illustrated, are provided in the through holes 5c, and two pieces of guide bars 7 constituting slide members are respectively inserted into the through holes 5c. Hence, the guide bars 7 are aligned to be provided on left and right sides in parallel with the upper face of the turn table 2, a rear side of the guide bar 7 is fixedly attached by a support 9 and a front side thereof is fixedly attached by a hinge 8, respectively, to restrict a range of sliding the guide bars 7. Further, a knob 10 provided at a side face of the holder 8 is for pressing the guide bar 7 to fix sliding thereof.

A circular saw portion 12 is axially supported by the hinge 8 pivotably in the up and down direction relative to the upper face of the base 1 by way of a shaft 11. Further, a spring 13 for urging the circular saw portion 12 in an upper direction is provided at an outer peripheral portion of the shaft 11 between the hinge 8 and the circular saw portion 12.

The circular saw portion 12 is provided with a handle 26 for pressing down the circular saw portion 12 in cutting, a motor 21 and a saw blade 14 and these are held by a gear case 20.

As shown by FIG. 2, the gear case 20 is provided with a saw blade shaft 15 in a horizontal direction, and one end of the saw blade shaft 15 is fixed with the saw blade 14 by a bolt 16. Further, the circular saw portion 12 is provided with a power transmitting mechanism constituted by a pulley, a transmission belt, a gear and the like for transmitting power from the motor 21 to the saw blade 14 although not illustrated. The motor 21 is arranged on an outer side of an outer periphery of the saw blade 14 and in a direction intersecting with an extension of the saw blade 14 and is provided to expand from both sides of the saw blade 14.

Further, a front face of the holder 5 is provided with stoppers 5a and 5b constituting positioning members in being inclined, and on a rear side of the upper face of the turn table 2, stopper bolts 30 and 31 constituting inclination adjusting members are screwed thereto in a vertical direction to be disposed on loci of moving stoppers 5a and 5b. When the holder 5 is inclined, the stoppers 5a and 5b are engaged with respective head portions of the stopper bolts 30 and 31 by predetermined angles of inclination to set a position of inclining the circular saw portion 12. Here, the stopper 30 is provided to be engaged with the stopper 5a when the holder 5 is inclined by 45° in a left direction. Further, the stopper bolt 31 is provided to be engaged with the stopper 5b when the holder 5 is inclined by 45° in a right direction.

Further, an upper portion of the turn table 2 is formed with a through hole 2b, the through hole 2b is inserted with a pin 32 constituting a positioning member at time of right angle horizontally movably, and in a state shown in FIG. 2, the holder 5 is screwed with a stopper bolt 33 in a direction orthogonal thereto to be disposed on a locus of moving the pin 32. When the holder 5 is disposed at the right angle cutting position, a front end of the stopper bolt 33 and an outer diameter portion of the pin 32 are brought into contact with each other.

In the above-described constitution, in order to cut the member to be worked 35 by right angle by setting the circular saw portion 12 at a vertical position, when the holder 5 is disposed at a vertical position, the pin 32 is moved to a front side to be disposed at a position at which the front end of the stopper bolt 33 constituting an inclination adjusting member and the outer diameter portion of the pin 32 are brought into contact with each other, the position of inclining the holder 5 is fixed by fastening the lever 6, and the member to be worked 35 can be cut under the state. In order to cut the member to be worked 35, the motor 21 is started by depressing a switch 27 provided at the handle 26. Then, the saw blade 14 is rotated by way of the power transmitting mechanism, the handle 26 is grabbed under the state, and the member to be worked 35 is cut by pressing down the circular saw portion 12 against an urge force of the spring 13. At a time point of finishing to cut the member to be worked 35, when the circular saw portion 12 is lifted, the circular saw portion 12 returns to an original upper limit position shown in FIG. 1 by the urge force of the spring 13. When an angle cutting is carried out, the turn table 2 is rotated and an operation of cutting the member to be worked 35 is carried out by the cutting method explained above.

Next, a method of inclining the circular saw portion 12 in the left and right direction will be explained.

The holder 5 is inclined in a left or right direction after releasing a state of fixing the holder 5 by loosening the lever 6. When the holder 5 is inclined in the left direction, the stopper 5a is brought into contact with the stopper bolt 30, and the circular saw portion 12 is positioned in a state of being inclined in the left direction by 45°. Under the state, the position of incline the holder 5 is fixed by fastening the lever 6. Thereafter, operation of cutting the member to be worked 35 can be carried out by the above-described cutting method.

Further, when the member to be worked 35 having a wide width is cut by right angle cutting, angle cutting, or inclination cutting, after the member to be worked 35 is pressed to a face of the fence 3 to be fixed, when the knob 10 is loosened and the guide bar 7 is pulled to a front side (side direction of FIG. 1), the guide bar 7 and the hinge 8 and the circular saw portion 12 are moved integrally to the front side. After a cut is provided by pressing down the handle 26, cutting is carried out while sliding the circular saw portion 12 to the rear side (a state shown in FIG. 3). After the cutting, when the press down force is weakened, the circular saw portion 12 is pushed up to the upper side by the urge force of the spring 13. Further, in the bench cutter according to the embodiment, compound cutting combined with the cutting method of sliding, right angle, angle, inclination cutting, angle cutting and the method of inclination cutting can also be carried out.

Further, according to the embodiment, a roller 18 is provided at a lower portion on the rear side of the table 2, the roller 18 is provided in parallel with the guide bar 7 at a position moved up from the installing face of the base 1.

When a product is moved in the front and rear direction and a direction thereof is changed in the operation, the product can be moved in the front and rear direction, or the direction can be changed in a state of receiving the bench cutter by the roller 18 by moving up a front side of the product by lifting the handle 26 by moving the circular saw portion 12 to the front side. Even in a state of setting the bench cutter to angular cutting or inclination cutting, the direction can be changed by moving the bench cutter by lifting the handle 26 similarly.

Further, in order to promote the performance of carrying the bench cutter, as shown by FIG. 5 and FIG. 6, the hinge 8 is embedded with a fixing pin 23 in parallel with the shaft 11, the gear case 20 of the circular saw portion 12 is provided with a recessed seat 20a to be able to insert an end portion of the fixing pin 23 and by inserting the fixing pin 23 to the recessed seat 20a at a position at which the circular saw portion 12 is moved down to lower side, the bench cutter can be downsized.

Further, by pulling the circular saw portion 12 to the front side, fastening the knob 10, fixing sliding of the guide bar 7 by pressing the guide bar 7, lifting the handle 26 as shown by FIG. 7, and bringing about a state of receiving the bench cutter by the roller 18 by moving up the front side of the bench cutter similar to the above-described, the bench cutter can be carried out with excellent operability and easily. Further, a stability in carrying the bench cutter is promoted by providing the rollers 18 on left and right sides relative to the extension of the saw blade 14.

### Embodiment 2

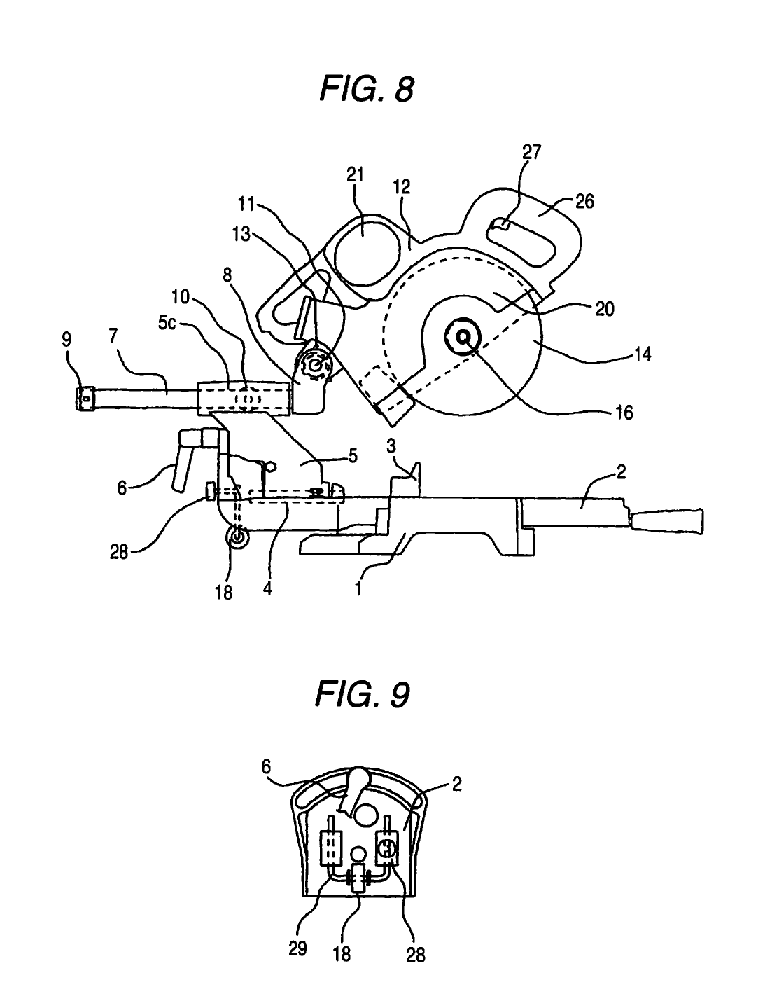

Next, embodiment 2 of the invention will be explained in reference to FIG. 8 and FIG. 9.

FIG. 8 is a left side view of a bench cutter according to embodiment 2 of the invention, FIG. 9 is a rear view of a turn table of the bench cutter, elements of the drawings the same as those shown in FIG. 1 through FIG. 4 are attached with the same notations, and in the following, a further explanation thereof will be omitted.

According to the embodiment, there is a case in which the roller 18 projected from an edge portion of the turn table 2 constitutes a hindrance when the turn table 2 is rotated in angle cutting or depending on a location of installing the bench cutter, and therefore, as shown by FIG. 8 and FIG. 9, by embedding a roller shaft 29 having the roller 18 to a rear portion of the turn table 2 movably in an upper direction and lifting the roller 18 and pressing the roller shaft 29 to fix by a fixing knob 28, the roller 18 is contained to be held in the turn table 2 to thereby promote the operability.

### Embodiment 3

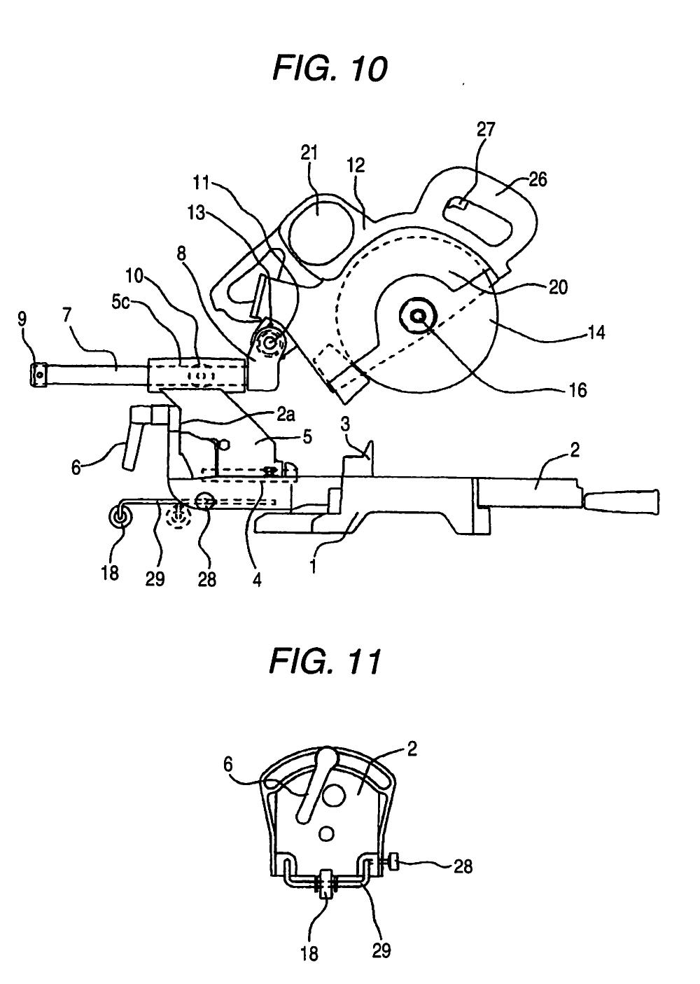

Next, embodiment 3 of the invention will be explained in reference to FIG. 10 and FIG. 11.

FIG. 10 is a left side view of a bench cutter according to embodiment 3 of the invention, FIG. 11 is a rear view of a turn table of the bench cutter, elements of the drawings the same as those shown in FIG. 1 through FIG. 4 are attached with the same notations, in the followings, a further explanation thereof will be omitted.

According to the embodiment, as shown by FIG. 10 and FIG. 11, the roller shaft 29 having the roller 18 is embedded on the rear side of the turn table 2 movably in the front and rear direction, and the roller shaft 29 is pressed by the fixing knob 28 to be able to fix. By changing the position of fixing the roller shaft 29 having the roller 18, the position of the handle 26 in carrying the bench cutter can be adjusted, and an operator can carry the bench cutter in an easy attitude.

1. A bench cutter in which a turn table is fitted to be held by a base portion horizontally pivotably, a fence for supporting a member to be worked is fixed onto the base portion, a rear side of the turn table is provided with a holder erected inclinably to the base portion, a circular saw portion is held in parallel and rotatably in an up and down direction relative to the upper face of the base portion, the circular saw portion is provided with a saw blade and a handle, and the member to be worked is cut by inclining, pivoting in the up and down direction and sliding in the front and rear direction the circular saw portion;
wherein a roller is provided with at least one of the base and the turn table.

2. The bench cutter according to claim 1, wherein the rollers are provided on left and right sides relative to an extension of the saw blade.

3. The bench cutter according to claim 1, wherein the roller is provided to be able to be contained in the turn table.

4. The bench cutter according to claim 1, wherein the roller is held movably in the front and rear direction.

5. The bench cutter according to claim 1, comprising:
a sliding member is connected to an upper portion of the holder, wherein the circular saw portion is slidable in a front and rear direction relative to an upper face of the base portion.

6. The bench cutter according to claim 1, wherein the roller is provided at a lower portion of a rear side of the turn table in parallel with a direction of sliding the circular saw portion in the front and rear direction by being moved up from an installing face of the base.
